(19) United States
(12) Patent Application Publication
(10) Pub. No.: US 2026/0227671 A1
(43) Pub. Date: Aug. 6, 2026

(54) MULTI-CHANNEL ACOUSTO-OPTIC SWITCH

(71) Applicant: Huawei Technologies Co., Ltd., Shenzhen (CN)

(72) Inventors: Patrick Dumais, Ottawa (CA); Eric Bernier, Kanata (CA); Andrew Ryan Woodard, Kanata (CA)

(21) Appl. No.: 19/047,420

(22) Filed: Feb. 6, 2025

(51) Int. Cl. G02F 1/33

(52) U.S. Cl. CPC G02F 1/33

(57) ABSTRACT

An optical switch is described. The optical switch includes: M input optical fibers configured to receive M optical signals respectively, where M is an integer greater than or equal to 1; a first acousto-optic deflector (AOD) configured to control a propagation direction of the M optical signals, such that the M optical signals are coupled to any one of N groups of output optical fibers; and the N groups of output optical fibers, where N is an integer greater than 1.

### TECHNICAL FIELD

The present disclosure generally relates to the field of optical communication and, in particular to, an optical switch.

### BACKGROUND

In the field of optical communication, multimode fiber links typically use vertical cavity surface-emitting lasers (VCSELs) as a light source. A bandwidth of a multimode fiber link is somewhat limited compared to a single-mode fiber link. However, a total cost of a multimode fiber link, including parts and assembly, is much lower than a single-mode fiber link. Therefore, to achieve an optical bandwidth greater than a single multimode fiber link can provide, there is a cost advantage in using multiple parallel multimode fiber links instead of fewer single-mode fiber links.

During an operation of a multimode fiber link or a single-mode fiber link, optical switches may be required to achieve switching of optical signals from an optical path to another. Fast switching, on a time scale of less than one microsecond, may be especially desirable for computing cluster applications. There remains room for further exploration of switching technologies and products in fiber links, especially multimode fiber links.

### SUMMARY

According to a first aspect, an optical switch is described. The optical switch includes: M input optical fibers configured to receive M optical signals respectively, where M is an integer greater than or equal to 1; a first acousto-optic deflector (AOD) configured to control a propagation direction of the M optical signals, such that the M optical signals are coupled to any one of N groups of output optical fibers, where the first AOD is configured to operate at a first frequency or a second frequency, an absolute value of a difference between the first frequency and a nominal frequency of the first AOD is equal to an absolute value of a difference between the second frequency and the nominal frequency of the first AOD, and the nominal frequency of the first AOD is an operating frequency that enables the first AOD to have a first nominal diffraction efficiency; and the N groups of output optical fibers, where N is an integer greater than 1, each of the N groups of output optical fibers includes M output optical fibers, and the N groups of output optical fibers are configured to output the M optical signals through M output optical fibers of the any one of the N groups of output optical fibers, respectively.

The first nominal diffraction efficiency may refer to a maximum diffraction efficiency of the first AOD. The nominal frequency of the first AOD may refer to an optimal frequency of the first AOD, i.e., an operating frequency that allows the first AOD to have the maximum diffraction efficiency.

Because the diffraction efficiency of the first AOD is symmetrical with respect to the change in driving frequency, the diffraction efficiency may be the same at the first and second frequencies. Because an insertion loss may depend on the diffraction frequency, the insertion loss of the first AOD may also be the same at the first and second frequencies. In an optical fiber communication system, the insertion loss is an important part of the total loss, and thus the loss of optical signals output by the optical switch in different operating states may be uniform. In other words, the power difference between different output optical signals may be small, e.g., less than a certain threshold value. Therefore, there may be no need to introduce either high-cost optical technologies or an additional power control, signal compensation, or regulation mechanism, which may be conducive to reducing a cost on a premise of meeting system performance.

In some embodiments, the optical switch further includes: a polarization splitter configured to split the M optical signals from the M input optical fibers into M first optical signals having a first polarization direction and M second optical signals having a second polarization direction orthogonal to the first polarization direction; a first waveplate configured to convert the M second optical signals from having the second polarization direction to having the first polarization direction, where the first AOD is further configured to control a propagation direction of the M first optical signals and the M second optical signals output from the first waveplate; a second waveplate configured to convert the M first optical signals output from the first AOD from having the first polarization direction to having the second polarization direction, or convert the M second optical signals from having the first polarization direction to having the second polarization direction; and a polarization combiner configured to combine the M first optical signals output from the second waveplate and the M second optical signals output from the first AOD, or configured to combine the M second optical signals output from the second waveplate and the M first optical signals output from the first AOD, to obtain and transmit combined M optical signals to the any one of the N groups of output optical fibers.

In this case, the optical signals may have the same polarization direction during a transmission between the two waveplates, which may be conducive to equalizing polarization-dependent loss (PDL) between the different optical signals, thereby enhancing the overall system performance.

In some embodiments, the optical switch further includes a second AOD configured to control a propagation direction of the M optical signals output from the first AOD, so that the M optical signals are coupled to the any one of the N groups of output optical fibers. A longitudinal axis of the second AOD overlaps a longitudinal axis of the first AOD, and a beam deflection axis of the second AOD is not parallel to a beam deflection axis of the first AOD.

In this case, the optical switch may achieve more possible output beam patterns, which may facilitate application of the optical switch to more scenarios.

In some embodiments, the second AOD is configured to operate at a third frequency or a fourth frequency. An absolute value of a difference between the third frequency and a nominal frequency of the second AOD is equal to an absolute value of a difference between the fourth frequency and the nominal frequency of the second AOD. The nominal frequency of the second AOD is an operating frequency that enables the second AOD to have a second nominal diffraction efficiency.

Similar to the first AOD, the second AOD may have a uniform loss between two output states at the third and fourth frequencies, which may be beneficial to reduce the cost while maintaining the system performance.

In some embodiments, the beam deflection axis of the second AOD is perpendicular to the beam deflection axis of the first AOD.

In this way, more possible output patterns may be provided for the optical switch.

In some embodiments, an angle between the beam deflection axis of the second AOD and the beam deflection axis of the first AOD is 60 degrees.

In this way, more possible output patterns may be provided for the optical switch.

In some embodiments, the optical switch further includes: a third AOD configured to control a propagation direction of the M optical signals output from the second AOD, so that the M optical signals are coupled to the any one of the N groups of output optical fibers. A longitudinal axis of the third AOD, the longitudinal axis of the second AOD and the longitudinal axis of the first AOD overlap, and a beam deflection axis of the third AOD is not parallel to either the beam deflection axis of the second AOD or the beam deflection axis of the first AOD.

In this case, the optical switch may achieve more possible output patterns, which may facilitate application of the optical switch in more scenarios.

In some embodiments, the first AOD is further configured to operate at the nominal frequency of the first AOD, the second AOD is further configured to operate at the nominal frequency of the second AOD, and the third AOD is further configured to operate at a fifth frequency, a sixth frequency, or a nominal frequency of the third AOD. An absolute value of a difference between the fifth frequency and the nominal frequency of the third AOD is equal to an absolute value of a difference between the sixth frequency and the nominal frequency of the third AOD, and the nominal frequency of the third AOD is an operating frequency that enables the third AOD to have a third nominal diffraction efficiency.

Similar to the first AOD and the second AOD, the third AOD may have uniform loss between two output states at the fifth and the sixth frequencies, which may be conducive to reducing the cost while maintaining the system performance.

In some embodiments, an angle between the beam deflection axis of the third AOD and the beam deflection axis of the second AOD is 60 degrees, an angle between the beam deflection axis of the third AOD and the beam deflection axis of the first AOD is 60 degrees, and an angle between the beam deflection axis of the second AOD and the beam deflection axis of the first AOD is 60 degrees.

In this way, more possible output patterns may be provided for the optical switch.

In some embodiments, the M input optical fibers are arranged in a two-dimensional array.

In a case where the M input fibers are arranged in a two-dimensional array, the input optical signals may have other relative positions to each other, thus facilitating the application of optical switch in more scenarios.

In some embodiments, a row direction and a column direction of the two-dimensional array are not perpendicular.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates a schematic diagram of an example computing cluster to which some implementations of the present disclosure may be applied;

FIG. 2 illustrates a block diagram of an optical switch, in accordance with some embodiments;

FIG. 3 illustrates a schematic diagram of the optical switch shown in FIG. 2, in accordance with some embodiments;

FIG. 4A illustrates a block diagram of an optical switch, in accordance with some embodiments;

FIG. 4B illustrates a schematic diagram of the optical switch shown in FIG. 4A, in accordance with some embodiments;

FIG. 4C illustrates a schematic diagram of another optical switch, in accordance with some embodiments;

FIG. 5 illustrates an input facet beam pattern for the optical switches shown in FIGS. 4B and 4C, in accordance with some embodiments;

FIG. 6 illustrates an output facet beam landing site pattern of output optical signals of the optical switch in a case of the input beam pattern shown in FIG. 5;

FIGS. 7 and 8 illustrate two possible output patterns of output optical signals of an optical switch in a case of the input facet beam pattern shown in FIG. 5;

FIG. 9 illustrates a front view of an example first AOD in the optical switch shown in FIGS. 4B and 4C, in accordance with some embodiments;

FIG. 10 illustrates a side view of the first AOD shown in FIG. 9;

FIG. 11 illustrates two possible output patterns of an input optical signal of the optical switch in a case where the first AOD operates at the position shown in FIGS. 9 and 10;

FIG. 12 illustrates a front view of an example first AOD in the optical switch shown in FIGS. 4B and 4C, in accordance with some embodiments;

FIG. 13 illustrates a side view of the first AOD shown in FIG. 12;

FIG. 14 illustrates two possible output patterns of an input optical signal of the optical switch in a case where the first AOD operates at the position shown in FIGS. 12 and 13;

FIG. 15 illustrates a front view of an example first AOD in the optical switch shown in FIGS. 4B and 4C, in accordance with some embodiments;

FIG. 16 illustrates a side view of the first AOD shown in FIG. 15;

FIG. 17 illustrates two possible output patterns of an input optical signal of the optical switch in a case where the first AOD operates at the position shown in FIGS. 15 and 16;

FIG. 18 illustrates an output facet beam landing site pattern of output optical signals of the optical switch in a case where the first AOD operates at the position shown in FIGS. 15 and 16;

FIGS. 19 and 20 illustrate two possible output patterns of output optical signals of the optical switch according to the output facet beam landing site pattern shown in FIG. 18;

FIG. 21 illustrates an input facet beam pattern for the optical switch shown in FIGS. 4B and 4C, in accordance with some embodiments;

FIG. 22 illustrates an output facet beam landing site pattern of output optical signals of the optical switch according to the input facet beam pattern shown in FIG. 21;

FIGS. 23 and 24 illustrate two possible output patterns of output optical signals of the optical switch according to the output facet beam landing site pattern shown in FIG. 22;

FIG. 25 illustrates an output facet beam landing site pattern of output optical signals of the optical switch according to the input facet beam pattern shown in FIG. 21;

FIGS. 26 and 27 illustrate two possible output patterns of output optical signals of the optical switch according to the output facet beam landing site pattern shown in FIG. 25;

FIG. 28A illustrates a block diagram of another optical switch in accordance with some embodiments;

FIG. 28B illustrates a schematic diagram of the optical switch shown in FIG. 28A, in accordance with some embodiments;

FIG. 29 illustrates a front view of example first and second AODs in the optical switch shown in FIG. 28B;

FIG. 30 illustrates a side view of the first AOD and the second AOD shown in FIG. 29;

FIG. 31 illustrates four possible output patterns of an input optical signal in a case where the first AOD and the second AOD operate at the position shown in FIGS. 29 and 30;

FIG. 32 illustrates a front view of example first and second AODs in the optical switch shown in FIG. 29;

FIG. 33 illustrates a side view of the first AOD and the second AOD shown in FIG. 32;

FIG. 34 illustrates four possible output patterns of an input optical signal in a case where the first AOD and the second AOD operate at the position shown in FIGS. 32 and 33;

FIG. 35 illustrates an output facet beam landing site pattern of output optical signals of the optical switch in a case where the first AOD and the second AOD operate at the position shown in FIGS. 29 and 30;

FIG. 36 illustrates four possible output patterns of output optical signals of the optical switch according to the output facet beam landing site pattern shown in FIG. 35;

FIG. 37 illustrates an output facet beam landing site pattern of output optical signals of the optical switch in a case where the first AOD and the second AOD operate at the position shown in FIGS. 32 and 33;

FIG. 38 illustrates four possible output patterns of the optical switch according to the output facet beam landing site pattern shown in FIG. 37;

FIG. 39A illustrates a block diagram of another optical switch, in accordance with some embodiments;

FIG. 39B illustrates a schematic diagram of the optical switch shown in FIG. 39A, in accordance with some embodiments;

FIG. 40 illustrates a front view of example first, second and third AODs in the optical switch shown in FIG. 39B, in accordance with some embodiments;

FIG. 41 illustrates a side view of the first AOD, the second AOD, and the third AOD shown in FIG. 40;

FIG. 42 illustrates an output facet beam landing site pattern of output optical signals of the optical switch in a case where the first AOD, the second AOD and the third AOD operates at the position shown in FIGS. 40 and 41;

FIG. 43 illustrates seven possible output patterns of the output optical signal of the optical switch according to the output facet beam landing site pattern shown in FIG. 42;

FIG. 44 illustrates an example input facet beam pattern for the optical switch shown in FIG. 39B, in accordance with some embodiments;

FIG. 45 illustrates an example output facet beam landing site pattern of output optical signals of the optical switch in a case where the first AOD, the second AOD, and the third AOD operate at the position shown in FIGS. 40 and 41;

FIG. 46 illustrates seven possible output patterns of the optical switch according to the output facet beam landing site pattern shown in FIG. 45; and

FIG. 47 illustrates an example output facet beam landing site pattern supplement.

### DETAILED DESCRIPTION

Embodiments of the present disclosure are described below with reference to the accompanying drawings.

For ease of understanding, the technical terms involved in the embodiments are first described below.

### 1. Optical Switch

In an optical fiber communication system, an optical switch may refer to a device configured to control routing or transmission of optical signals within a network by using various techniques to selectively switch or redirect optical paths. Unlike conventional electronic switches, an optical switch may achieve the switching function of signals by manipulating a propagation path of light waves without relying on an electric current, and thus may be widely used in high-speed, high-capacity optical communication networks.

### 2. Acousto-Optic Effect

An acousto-optic effect may refer to a phenomenon that a change in refractive index is induced in a material by an acoustic wave, resulting in the formation of a grating that can diffract light. This effect may be utilized in devices such as beam deflectors and switches.

### 3. Acousto-Optic Deflector (AOD)

An AOD is a device that operates on the basis of the acousto-optic effect and is typically used in laboratory settings for beam scanning. An AOD typically consists of a solid medium, typically crystalline, and a piezo-electric transducer. When the piezo-electric transducer is driven by an electrical signal, typically an electrical sine wave, a so-called acoustic wave propagates in the solid medium. This acoustic wave may cause a spatially periodic modulation of the refractive index of the solid medium, which is also called a Bragg grating. A laser beam incident to the AOD may experience a very efficient diffraction effect from the Bragg grating, causing most of the incident laser beam's power to be deflected in a different direction than the incident one. As the period of the Bragg grating depends directly on the frequency of the acoustic wave, a change in the electrical signal frequency will result in a change in the deflection angle of the laser beam, thus achieving the beam scanning function.

A diffraction efficiency of an AOD may be a ratio of an intensity of a beam deflected out of an incident beam after a diffraction process to a total intensity of the incident beam. It is a key parameter for measuring a performance of the AOD and is usually expressed as a percentage. The diffraction efficiency of the AOD is usually related to an operating frequency of the AOD, which is a frequency of an acoustic wave that drives the AOD, which is also known as a driving frequency. A driving frequency that makes the AOD have a maximum diffraction efficiency is called an optimal frequency. A typical driving frequency for such an AOD is 100 megahertz (MHz), and a correspondingly typical deflection angle is 20 milliradian (mrad). A speed at which a laser beam may be scanned is related to the driving frequency and a propagation time of the acoustic wave across the width of the beam. With a driving frequency on the order of 100 MHz, sub-microsecond response times for such an AOD may be achieved.

It is noticed that the driving frequency may affect a deflection angle of a beam. In general, there is a linear relationship between the deflection angle and the driving frequency. In other words, when the driving frequency deviates from the optimal frequency, a change in deflection angle is usually proportional to a change in frequency. For example, if there are two frequencies, they are equal in difference to the optimal frequency, and they may cause beams to be deflected at a same angle away from that of the optimal frequency, but in opposite directions.

It is also noticed that in the AOD, the diffraction efficiency usually varies with the driving frequency. In general, the diffraction efficiency reaches a maximum at the optimal frequency and then decreases as the driving frequency is reduced or increased. Typically, the diffraction efficiency usually exhibits symmetry as a function of the driving frequency. For example, two driving frequencies with a same offset result in a same degree of diffraction efficiency degradation, whether the driving frequencies are increased or decreased, so that the AOD may offer a high degree of symmetry and flexibility in scanning and beam control.

As an optical device, the AOD uses acoustic waves to modulate a propagation path of an optical signal, enabling rapid deflection or selective transmission of the optical signal. Therefore, the AOD is particularly suitable for optical communication as a high-performance, low-power, high-speed optical switching element.

### 4. Polarization-Dependent Loss (PDL)

PDL for a component or system may be a maximum, peak-to-peak insertion loss (or gain) variation caused by a component when stimulated by all possible polarization states. Because optical fibers or optical devices may have different loss characteristics for optical signals with different polarization directions, PDLs for the optical signals with different polarization directions may be different. In an optical fiber communication system, PDL may be a main system performance limiting factor. PDL may cause a difference in signal power and imbalance of optical signal-to-noise ratio (OSNR) between two polarization branches. The OSNR asymmetry may eventually deteriorate the overall system performance.

### 5. Insertion Loss

In optical fiber communication systems, insertion loss is an important part of the total loss. Insertion loss may refer to a loss of signal power due to an insertion of a device or equipment. In other words, insertion loss may represent an attenuation of an optical signal by the device, and is usually expressed in decibels (dB). It is noticed that the insertion loss may depend on the diffraction efficiency.

For example, in an AOD, a higher diffraction efficiency means that more of incident light is effectively diffracted or deflected out, leaving less light, and therefore less insertion loss, while a lower diffraction efficiency means that most of the light is not deflected, leaving more light, and therefore more insertion loss. In the AOD, the same diffraction efficiency often corresponds to the same insertion loss.

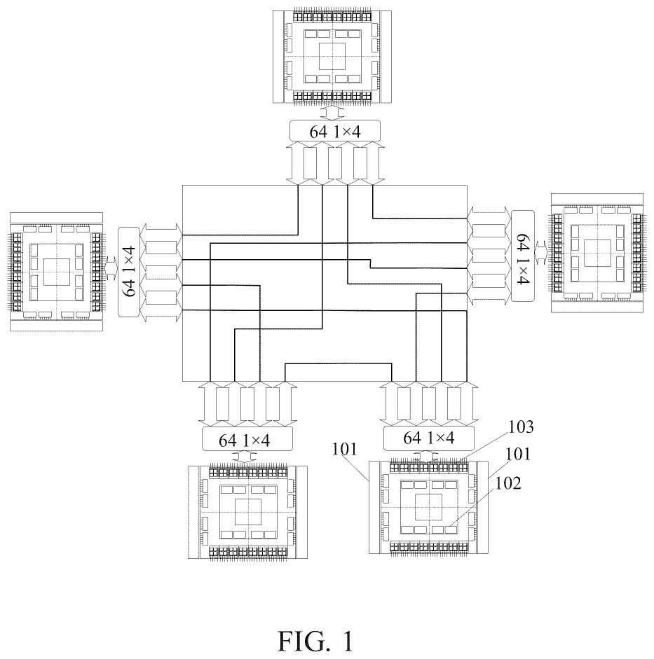

Technical solutions of embodiments of the present disclosure may be applied in many scenarios where optical switches, especially large-scale optical switches, are required. For example, a computing cluster including many computing engines may be beneficially interconnected with optical links and optical switches. FIG. 1 shows a schematic diagram of an example computing cluster. The compute cluster includes five computing engines. Each computing engine includes two high bandwidth memory (HBM) modules 101 and a plurality of central processing units (CPUs) 102. The HBM modules 101 may be used to increase data transmission rate and bandwidth. The CPUs 102 may be used for computational tasks for processing large-scale data.

As shown in FIG. 1, the cluster of five computing engines may be fully meshed by employing multi-channel 1×4 switches. The shoreline of each computing engine is served by 8 optical interfaces 103, each of which may include 256 fibers providing 1.6 terabits per second (Tb/s) connectivity per interface. Thus, for each optical interface 103, eight 32-channel 1×4 optical switches (i.e., 64 32-channel 1×4 optical switches may be used at the shoreline of each computing engine) may be used. Therefore, connectivity and control between the five computing engines may be achieved.

AODs have been widely used in optical switches. For example, an optical switch based on AOD works as follows. An optical beam coming from an input optical fiber propagates through an acousto-optic medium of the AOD. The AOD is driven by an acoustic frequency, switching between an “off” state and an “on” state, so as to achieve a deflection and output of the optical beam.

Another example is a fast 1×2 switch for a multimode fiber including a variable waveplate. The variable waveplate is described as either an electro-optic or magneto-optic medium. The switching function of this switch is achieved through a polarization rotation induced in the electro-optic or magneto-optic medium. The electro-optic or magneto-optic medium may be collectively referred to as an active medium. Other optical elements in this switch may separate an input beam into two distinct, spatially separated, beams of different polarization. The two resulting beams may go through the active medium. The active medium may rotate or not rotate the polarization orientation of the two beams, depending on whether the active medium is in an “on” or “off” state. In the “on” state, the result is that the polarization orientation of both beams is rotated by 90 degrees. Following this, a waveplate rotates only one of polarization states, so that both beams have the same polarization orientation. Following this, other optical elements are disposed as to rotate the polarization orientation of one of the beams, and then combine them into a single beam. This happens for both possible optical paths. Finally, the one remaining beam is coupled to one of the two output fibers, depending which of the two possible positions in space this beam is located. In this way, a beam switching function is achieved.

In addition, there is a fast multicasting 4×4 photonic space switch utilizing acousto-optic Bragg cells. This switch may utilize four 1×4 acousto-optic switches for single-mode optical fibers, which are combined by using four 4×1 power combiners that combine respective four outputs of the four acousto-optic switches.

These optical switches described above may perform the switching function with some non-uniform loss between output states, which means that the optical signals output by the optical switch in different operating states may have non-uniform loss. This un-uniform loss may result in inconsistent signal attenuation, so that there may be a large power difference between different output optical signals, which may be, for example, greater than a certain threshold value, thereby affecting a quality of the optical signals. This may be particularly detrimental to long-distance transmission or high-speed communication, and may result in increased bit error rate (BER) or transmission errors, thereby degrading system performance.

One possible solution to the problem of un-uniform loss is to introduce micro electro mechanical systems (MEMS) or liquid crystal on silicon (LCoS) technology, which have a switching speed much larger than one microsecond. Thus, it may be costly to implement fast optical switches for multimode links on a large scale, for example in a computing cluster where every CPU may include multiple optical links. Another possible solution is to introduce additional power control, signal compensation or regulation mechanisms. For example, optical power conditioners, compensation modules, etc., are added, which may increase manufacturing and maintenance costs. For example, in the computing cluster shown in FIG. 1, each CPU includes multiple optical links, so a large number of optical switches are required to control the optical links, which may result in a high cost issue if additional regulation mechanisms are introduced.

In view of this, some embodiments of the present disclosure provide an optical switch, which includes an AOD configured to control a propagation direction of optical signals, such that the optical signals may be coupled to any group of output optical fibers. It is noticed that the AOD may operate at two frequencies, and an absolute value of a difference between one of the two frequencies and an optimal frequency of the AOD is equal to an absolute value of a difference between another of the two frequencies and the optimal frequency of the AOD. Therefore, the losses of the optical signals output by the AOD at these two frequencies may be uniform. In this way, there may be no need to introduce other technologies or signal compensation mechanisms, which may be conducive to cost reduction while ensuring system performance.

It is understood that the optical switch according to some embodiments of the present disclosure may be applied to the computing cluster shown in FIG. 1, and may also be applied to other systems requiring optical switches.

In the present disclosure, a beam, light, an optical beam and an optical signal may have a same meaning and may be interchangeable.

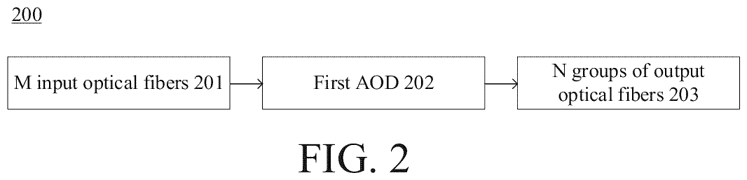

FIG. 2 illustrates a block diagram of an optical switch in accordance with some embodiments of the present disclosure. As shown in FIG. 2, the optical switch 200 includes M input optical fibers 201, a first AOD 202, and N groups of output optical fibers 203. M is an integer greater than or equal to 1, and N is an integer greater than 1.

The M input optical fibers 201 are configured to receive M optical signals, respectively.

The first AOD 202 is configured to control a propagation direction of the M optical signals, such that the M optical signals are coupled to any one of the N groups of output optical fibers 203. The first AOD 202 is configured to operate at a first frequency or a second frequency. An absolute value of a difference between the first frequency and a nominal frequency of the first AOD 202 is equal to an absolute value of a difference between the second frequency and the nominal frequency of the first AOD 202, and the nominal frequency of the first AOD 202 is an operating frequency that enables the first AOD 202 to have a first nominal diffraction efficiency.

It is noticed that the first nominal diffraction efficiency refers to a maximum diffraction efficiency of the first AOD 202. The nominal frequency of the first AOD 202 refers to an optimal frequency of the first AOD 202, i.e., an operating frequency that allows the first AOD 202 to have the maximum diffraction efficiency.

As mentioned earlier, each AOD 202 has an optimal frequency at which the diffraction efficiency is highest and thus the insertion loss is lowest. The optimal frequency may be set or determined by grating equations. For example, the optimal frequency may be determined by a relationship between the Bragg grating period and the driving frequency. In an implementation, a Bragg grating period A may be calculated as:

$$Λ = \frac{v}{F} \qquad ( 1 )$$

Where v is an acoustic wave velocity and F is an acousto-optic frequency (i.e., the driving frequency). A Bragg angle may be calculated by a light wavelength λ and the Bragg grating period A:

$$sin {θ}_{B} = \frac{λ}{2 Λ} \qquad ( 2 )$$

In a case where an optical signal enters an AOD, and an angle of incidence θᵢ is equal to θ_{B}, the optimal frequency f₀ may be calculated as:

$${f}_{0} = \frac{λ v}{2 sin {θ}_{i}} \qquad ( 3 )$$

Because the absolute value of the difference between the first frequency and the optimal frequency of the first AOD 202 is equal to the absolute value of the difference between the second frequency and the optimal frequency of the first AOD 202 (e.g., the optimal frequency is 100 MHz, the first frequency is 90 MHz and the second frequency is 110 MHz), the first AOD 202 may deflect an optical signal at a same angle but in an opposite direction when operating at the first frequency than when operating at the second frequency.

It is also noticed that any one of the optimal frequency, the first frequency and the second frequency of the first AOD 202 may be pre-set or set by a user based on calculations or otherwise determined.

Each of the N groups of output optical fibers 203 includes M output optical fibers, and the N groups of output optical fibers 203 are configured to output the M optical signals through M output optical fibers of the any one of the N groups of output optical fibers, respectively.

As mentioned earlier, because the diffraction efficiency exhibits symmetry as a function of the driving frequency, the diffraction efficiency of the first AOD 202 may be the same at these two operating frequencies (i.e., the first and second frequencies). Because an insertion loss may depend on the diffraction frequency, the insertion loss of the first AOD 202 may also be the same at both operating frequencies. In an optical fiber communication system, an insertion loss is an important part of the total loss, and thus the optical switch 200 may perform the switching function with uniform loss between output states, which means that the optical signals output by the optical switch 200 in different operating states may have uniform loss. In other words, there may be a small power difference between the different output optical signals, which is, for example, less than a certain threshold value. Therefore, the uniform loss may be achieved for the different output states without introducing high-cost optical technologies (e.g., MEMS or LCOS) and an additional power control, signal compensation, or regulation mechanism, which may be conducive to reducing a cost on a premise of ensuring the system performance.

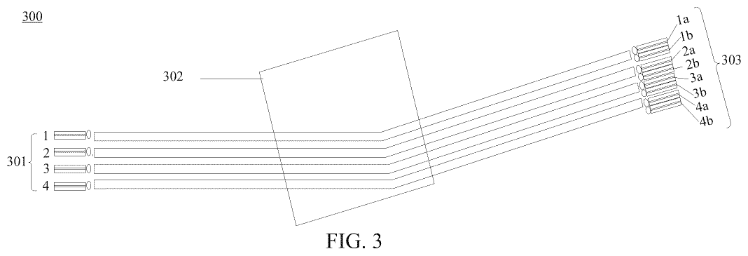

FIG. 3 illustrates a schematic diagram of an optical switch in accordance with some embodiments of the present disclosure. As shown in FIG. 3, the optical switch 300 includes four input optical fibers 301, a first AOD 302 and two groups of output optical fibers 303. That is, M=4 and N=2.

For each of optical signals received by the four input fibers, there are two possible output patterns. For example, for an optical signal received by input optical fiber 1 (which may also be referred to as “input optical signal 1”), the input optical signal 1 may be output via output optical fiber 1a, and the output optical signal may be referred to as output optical signal 1a. The input optical signal 1 may also be output via output optical fiber 1b, and the output optical signal may be referred to as output optical signal 1b. For an optical signal received by input optical fiber 2 (which may also be referred to as “input optical signal 2”), the input optical signal 2 may be output via output optical fiber 2a, and the output optical signal may be referred to as output optical signal 2a. The input optical signal 2 may also be output from output optical fiber 2b, and the output optical signal may be referred to as output optical signal 2b. For optical signals received by input optical fibers 3 and 4 (which may also be referred to as input optical signals 3 and 4 respectively), there may be similar output patterns, which will not be repeated here. The optical switch shown in FIG. 3 is a 4-channel 1×2 switch.

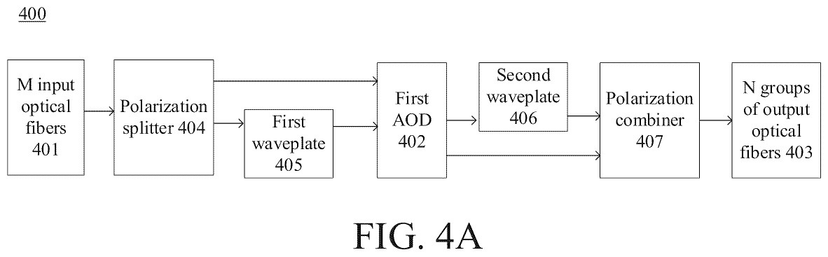

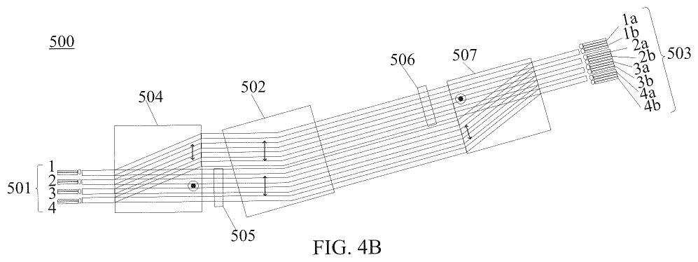

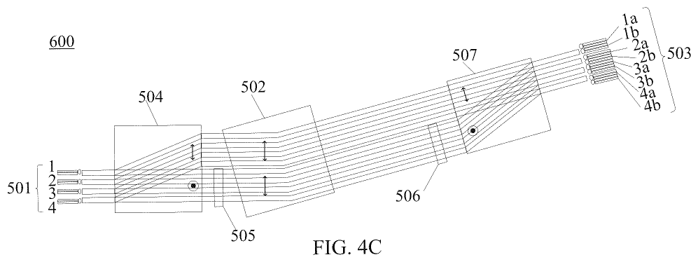

FIG. 4A illustrates a block diagram of an optical switch in accordance with some embodiments of the present disclosure. FIG. 4A is similar to FIG. 2, and the same parts are not repeated here.

In some embodiments, as shown in FIG. 4A, the optical switch 400 may further include a polarization splitter 404, a first waveplate 405, a second waveplate 406, and a polarization combiner 407.

The polarization splitter 404 is configured to split the M optical signals from the M input optical fibers 401 into M first optical signals having a first polarization direction and M second optical signals having a second polarization direction orthogonal to the first polarization direction.

The first waveplate 405 is configured to convert the M second optical signals from having the second polarization direction to having the first polarization direction.

In this case, the first AOD 402 is configured to control a propagation direction of the M first optical signals and the M second optical signals output from the first waveplate 405.

The second waveplate 406 is configured to convert the M first optical signals output from the first AOD 402 from having the first polarization direction to having the second polarization direction, or convert the M second optical signals output from the first AOD 405 from having the first polarization direction to having the second polarization direction.

The polarization combiner 407 is configured to combine the M first optical signals output from the second waveplate 406 and the M second optical signals output from the first AOD 402, or configured to combine the M second optical signals output from the second waveplate 406 and the M first optical signals output from the first AOD 402, to obtain and transmit combined M optical signals to the any one of the N groups of output optical fibers 403.

FIG. 4B illustrates an optical switch in accordance with some embodiments of the present disclosure. FIG. 4B is similar to FIG. 3, and the same parts are not repeated here.

For example, as shown in FIG. 4B, the polarization splitter 504 splits the four input optical signals 1, 2, 3, and 4 into four first optical signals having a first polarization direction (i.e., a direction parallel to the paper surface) and four second optical signals having a second polarization direction (i.e., a direction perpendicular to the paper surface) orthogonal to the first polarization direction.

The first waveplate 505 converts the four second optical signals from having the direction perpendicular to the paper surface to the direction parallel to the paper surface. Thus, the four first optical signals and the four second optical signals in the first AOD 502 have the same polarization direction.

In this case, a propagation direction of the four first optical signals and the four second optical signals may be deflected by the first AOD 502.

The second waveplate 506 converts the four first optical signals output from the first AOD 502 from having the direction parallel to the paper surface to the direction perpendicular to the paper surface.

In another implementation, as an optical switch 600 shown in FIG. 4C, the second waveplate 507 converts the four second optical signals output from the first AOD 502 from having the direction parallel to the paper surface to the direction perpendicular to the paper surface.

The four first optical signals and the four second optical signals enter the polarization combiner 507. It is noticed that in this case, the polarization direction of the four first optical signals is orthogonal to the polarization direction of the four second optical signals. The polarization combiner 507 combines the four first optical signals and the four second optical signals, and transmits combined four optical signals to two groups of output optical fibers 403. Similar to FIG. 3, for each of the combined four optical signals, there are two possible output patterns.

It is noticed that the changes in the polarization direction of the optical signals by the first waveplate 505 and the second waveplate 506 are merely exemplary in the above process. A main purpose of the first waveplate 505 and the second waveplate 506 is to make the optical signals have a same polarization direction during transmission between the two waveplates. In another possible implementation, the first waveplate 505 may convert the four first optical signals from having the first polarization direction to having the second polarization direction. Correspondingly, the second waveplate 506 may convert the four first optical signals from having the second polarization direction to having the first polarization direction.

As mentioned earlier, optical signals having different polarization directions may have different loss. In this case, the optical signals having the same polarization direction during transmission between the two waveplates may be conducive to reducing the PDL difference between the different optical signals, thereby enhancing the overall system performance.

In the optical switch shown in FIGS. 4B and 4C, each of the four first optical signals and the four second optical signals may be separated from another due to the polarization splitter 504 (i.e., channel isolation is introduced), and the four first optical signal (or the four second optical signal) adjacent to each other. In this case, there may be no need to use multiple waveplates or a system including a combination of multiple hierarchical waveplates (e.g., interleaved waveplates). Instead, two separate waveplates (e.g., the first waveplate505 and the second waveplate 506) may be used to control polarization directions of the optical signals, and there may be no interference between the different optical signals, which may reduce system complexity.

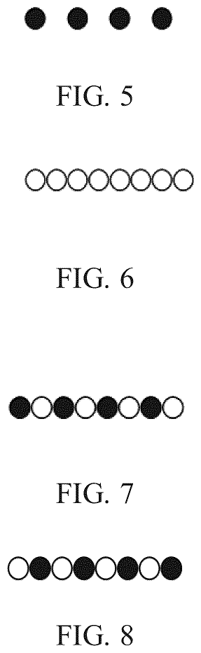

FIG. 5 illustrates an input facet beam pattern for the optical switch shown in FIG. 3 or 4B. The four dots in FIG. 5 indicate an input facet beam pattern of the input optical signals. All four solid dots indicate that four input optical signals, e.g., input optical signals 1, 2, 3, 4 shown in FIG. 3 or 4B, are separated to each other and are arranged in a line.

FIG. 6 illustrates an example output facet beam landing site pattern of output optical signals of the optical switch in a case of the input facet beam pattern shown in FIG. 5. Possible landing sites may refer to possible positions of optical signals at a receiving end, for example, the possible positions of the output optical signals in the output optical fibers. As shown in FIG. 6, there are eight dots indicating possible landing sites for the output optical signals. For example, the landing sites of the output optical signals may correspond to the eight output optical fibers 303.

It is noticed that, as mentioned earlier, in a case where the first AOD is operated at a certain frequency, deflection angles of all optical signals may be the same. For example, in a case where the first AOD is operated at the first frequency, the input optical signals 1, 2, 3 and 4 are output from the output optical fibers 1a, 2a, 3a, 4a, respectively. As shown in FIG. 7, the four solid dots may be actual landing sites of the output optical signals, indicating a possible output pattern. For another example, in a case where the first AOD is operated at the second frequency, the input optical signals 1, 2, 3 and 4 may be output from the output optical fibers 1b, 2b, 3b, 4b, respectively. As shown in FIG. 8, the four solid dots may be the actual landing sites of the output optical signals, indicating another possible output pattern.

In some embodiments, the first AOD may be rotated with a longitudinal axis as an axis of rotation. The longitudinal axis may refer to an operational axis of the first AOD. A position at which the first AOD operates may be a pre-rotation position or a post-rotation position. In this case, an extending direction of a beam deflection axis corresponding to the pre-rotation position of the first AOD and an extending direction of a beam deflection axis corresponding to the post-rotation position of the first AOD may be different. The beam deflection axis may refer to a line connecting landing sites of output optical signals.

In a case where the first AOD is rotated by a certain angle and then operated, the beam deflection axis may also be rotated by the same angle. In this case, a position of a certain component (e.g., an acousto-optic transducer, which may be configured to convert electrical signals into acoustic waves and to modulate or deflect an optical beam using the acoustic waves) in the first AOD is relatively fixed with respect to the beam deflection axis. For ease of understanding, the rotation of the first AOD may be represented by a change in a position of the acousto-optic transducer in the optical switch, thereby representing a change in the beam deflection axis. For the first AOD shown in FIG. 3 or 4B, there may be two possible output patterns (as shown in FIGS. 7 and 8). The extending directions of the beam deflection axes in these two output patterns are parallel.

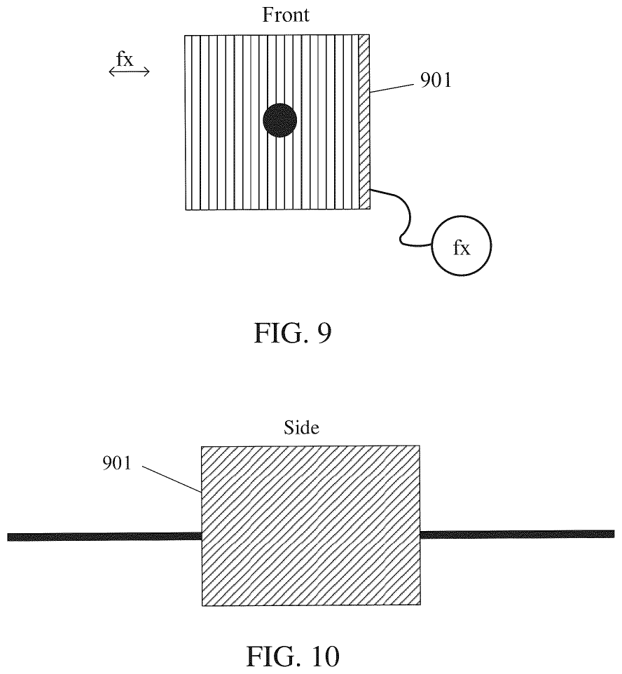

For ease of understanding, possible positions and output patterns of the first AOD will be described below, using an optical signal as an example, in conjunction with FIGS. 9 to 17.

FIG. 9 illustrates a front view of the first AOD in the optical switch shown in FIGS. 4B and 4C. The front view represents features of the first AOD as seen along the direction in which the input optical signals travel, e.g., the surface of the first AOD 502 shown in FIG. 4B adjacent to the first waveplate 505. The black dot indicates that the operational axis of the first AOD is orientated perpendicular to the paper surface. The first AOD may include an acousto-optic transducer 901. In a case where the first AOD operates at the position shown in FIG. 9, landing sites of the output optical signals may be arranged along the direction fx, that is, the beam deflection axis extends in the direction fx. As mentioned earlier, relative positions of the acousto-optic transducer 901 and the beam deflection axis may be fixed for the same AOD. For example, they may be perpendicular to each other. In the view shown in FIG. 9, the direction fx may be the horizontal direction and the acousto-optic transducer 901 may extend in a vertical direction.

FIG. 10 illustrates a side view of the first AOD shown in FIG. 9. For example, FIG. 10 illustrates a right view with the thick line indicating the operational axis.

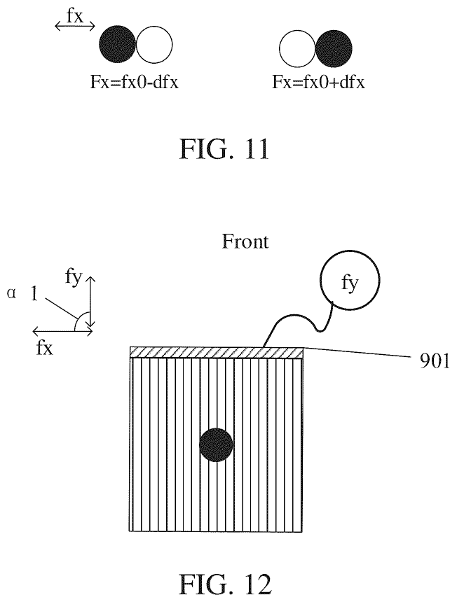

FIG. 11 illustrates two possible output patterns of the optical switch in a case where the first AOD operates at the position shown in FIGS. 9 and 10. In FIG. 11. Fx may refer to a landing site of an output optical signal after the first AOD deflects an input optical signal in the direction fx in a case where the first AOD operates at the first or second frequency. fxo may refer to a landing site of an output optical signal after the first AOD deflects an input optical signal in the direction fx in a case where the first AOD operates at an optimal frequency. dfx refers to a distance between fxo and the landing site of the output optical signal after the first AOD deflects the input optical signal in the direction fx in a case where the first AOD operates at the first or second frequency. As shown in FIG. 11, there are two possible output patterns (which may correspond to output optical signal 1a and output optical signal 1b).

In a possible implementation, Fx=fxo-dfx, indicating that the first AOD operates at the first frequency, which deviates from the optimal frequency and less than the optimal frequency. In another possible implementation, Fx=fxo+dfx, indicating that the first AOD operates at the second frequency, which deviates from the optimal frequency and is greater than the optimal frequency. Because an interval between the first frequency and the optimal frequency may be equal to an interval between the second frequency and the optimal frequency, a difference between an offset of an output optical signal due to the first frequency and an offset of an output optical signal due to the optimal frequency may be equal to a difference between an offset of an output optical signal due to the second frequency and the offset of the output optical signal due to the optimal frequency, and the difference is dfx.

FIGS. 12 and 13 illustrate front and side views of an example first AOD in the optical switch shown in FIGS. 4B and 4C, respectively. For example, FIG. 13 illustrates a right view. FIG. 12 is similar to FIG. 9, FIG. 13 is similar to FIG. 10, and same parts are not repeated here. The difference is that, compared to the position of the first AOD shown in FIGS. 9 and 10, the first AOD shown in FIGS. 12 and 13 is rotated 90 degrees in a counterclockwise direction using the longitudinal axis as the axis of rotation. Accordingly, the beam deflection axis changes from extending along the direction fx to extending along the direction fy. An angle a1 between the directions fx and fy is 90 degrees, and the direction fy may be the vertical direction.

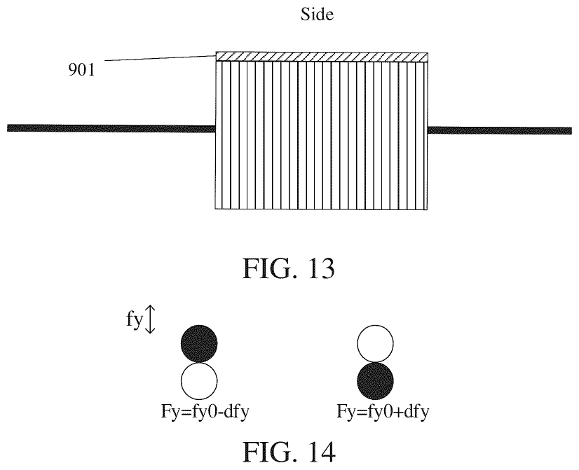

FIG. 14 illustrates two possible output patterns in a case where the first AOD operates at the position shown in FIGS. 12 and 13. In FIG. 14, Fy may refer to a landing site of an output optical signal after the first AOD deflects an input optical signal in the direction fy in a case where the first AOD operates at the first or second frequency. fyo may refer to a landing site of an output optical signals after the first AOD deflects an input optical signal in the direction fy in a case where the first AOD operates at the optimal frequency. dfx may refer to a distance between fyo and the landing site of an output optical signal after the first AOD deflects the input optical signal in the direction fy in a case where the first AOD operates at the first or second frequency. In FIG. 14, there are two possible output patterns. For example, the two output patterns may correspond to the output optical signal 1a and the output optical signal 1b.

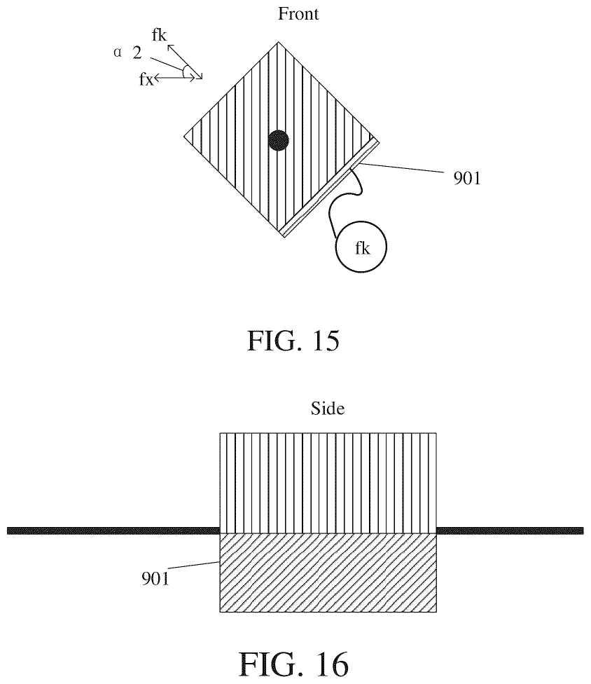

FIGS. 15 and 16 illustrate front and side views of an example first AOD in the optical switch shown in FIGS. 4B and 4C, respectively. For example, FIG. 16 illustrates a right view. FIG. 15 is similar to FIG. 9, FIG. 16 is similar to FIG. 10, and the same parts are not repeated here. The difference is that, compared to the position of the first AOD shown in FIGS. 9 and 10, the first AOD shown in FIGS. 15 and 16 is rotated 45 degrees in a clockwise direction with the longitudinal axis as the axis of rotation. Accordingly, the beam deflection axis changes from extending along the direction fx to extending along the direction fk. An angle a2 between the directions fx and fk is 45 degrees.

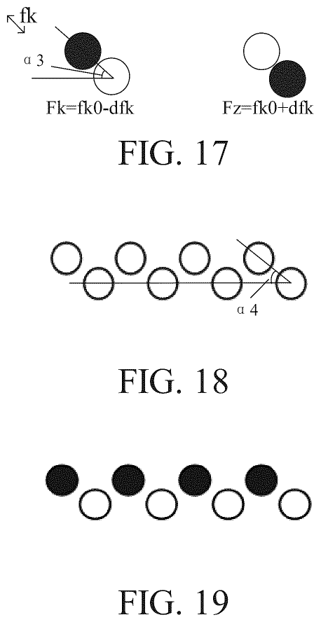

FIG. 17 illustrates two possible output patterns in a case where the first AOD operates at the position shown in FIGS. 15 and 16. In FIG. 17, Fk may refer to a landing site of an output optical signal after the first AOD deflects an input optical signal in the direction fk in a case where the first AOD operates at the first or second frequency. fzko may refer to a landing site of an output optical signals after the first AOD deflects an input optical signal in the direction fk in a case where the first AOD operates at the optimal frequency. dfk may refer to a distance between fko and a landing site of an output optical signal after the first AOD deflects the input optical signal in the fk direction in a case where the first AOD operates at the first or second frequency. As mentioned earlier, the direction fx may be a horizontal direction. So an angle α3 between the beam deflection axis and the horizontal direction is 45 degrees. As shown in FIG. 17, there are two possible output patterns. The two output patterns may correspond to the output optical signal 1a and the output optical signal 1b.

It is noticed that only some examples of rotation angles of the first AOD are described herein, but in actual application, the first AOD may have any other rotation angle.

Possible positions and output patterns of the first AOD will be described below in conjunction with FIGS. 18 to 20, using four optical signals as an example.

FIG. 18 illustrates possible landing sites of output optical signals in a case where the first AOD is in the position shown in FIGS. 15 and 16. FIG. 18 is similar to FIG. 6, with a difference that relative positions between the landing sites of the output optical signals have been changed. Compared to the position shown in FIGS. 9 and 10 (where the first AOD in this position may result in the landing sites of the output optical signals shown in FIG. 6), the position of the first AOD shown in FIGS. 15 and 16 has been changed (the first AOD has been rotated by 45 degrees). In this case, the first AOD may result in the landing sites of the output optical signals shown in FIG. 18. A line connecting a landing site of an output optical signal of the first AOD operating at the first frequency and an adjacent landing site of an output optical signal of the first AOD operating at the second frequency may be at an angle of 45 degrees (instead of being parallel) to a line connecting landing sites of output optical signals of the first AOD operating at the first or second frequency. That is, the angle α4 in FIG. 18 is 45 degrees.

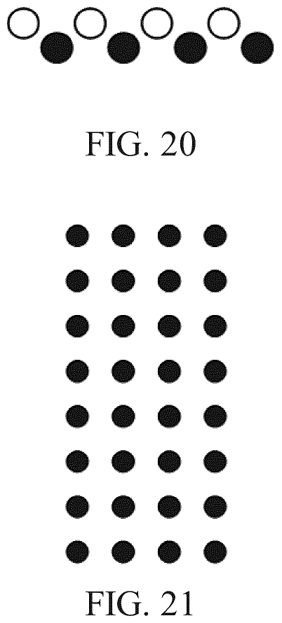

FIGS. 19 and 20 illustrate two possible output patterns of the optical switch according to the possible landing sites of the output optical signals shown in FIG. 18.

As mentioned earlier, in a possible implementation, in a case where the input facet beam pattern is shown in FIG. 5, and the position of the first AOD is shown in FIGS. 9 and 10, possible landing sites for the output optical signals are shown in FIG. 6, and the two possible output patterns are shown in FIGS. 7 and 8.

In another possible implementation, in a case where the input facet beam pattern is shown in FIG. 5, and the position of the first AOD is shown in FIGS. 15 and 16, possible landing sites for the output optical signals are shown in FIG. 18 and the two possible output patterns are shown in FIGS. 19 and 20. In this case, landing sites of output optical signals at different operating frequencies may not be arranged in a straight line, so that a distance between landing sites of two neighboring optical signals at a same operating frequency may be greater, which may increase a channel isolation, solve a crosstalk problem and improve the system stability.

In some embodiments, the M input optical fibers are arranged in a one-dimensional array.

For example, as shown in FIG. 5, M=4, and the input facet beam pattern of the four input optical signals indicates that the input optical fibers are arranged in a one-dimensional array.

In some other embodiments, the M input optical fibers are arranged in a two-dimensional array.

FIG. 21 illustrates an input facet beam pattern for the optical switch shown in FIGS. 4B and 4C. In FIG. 21, M=32, and there are 32 solid dots, indicating that 32 input optical signals may exist. The facets of the 32 input optical signals are not arranged in a straight line, but are arranged in a 4×8 pattern. There are 8 rows of facets of the input optical signals in FIG. 21, and each row of facets may be regarded as an input facet beam pattern shown in FIG. 5, so that the pattern shown in FIG. 21 may be viewed as consisting of 8 patterns shown in FIG. 5.

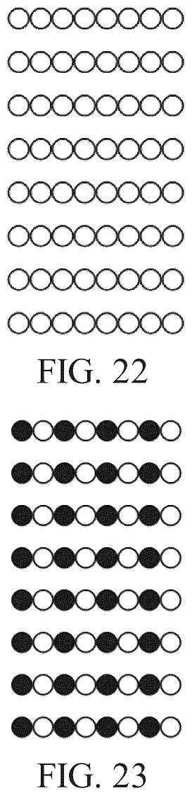

In a case where the first AOD is in the position shown in FIGS. 9 and 10, and the input optical signals are arranged as shown in FIG. 21, possible landing sites of output optical signals will be described in conjunction with FIGS. 22 to 24.

FIG. 22 illustrates possible landing sites of output optical signals of the optical switch according to the input facet beam pattern shown in FIG. 21. As shown in FIG. 22, the possible landing sites of the output optical signals are arranged in a two-dimensional array, which may be viewed as consisting of eight patterns shown in FIG. 6.

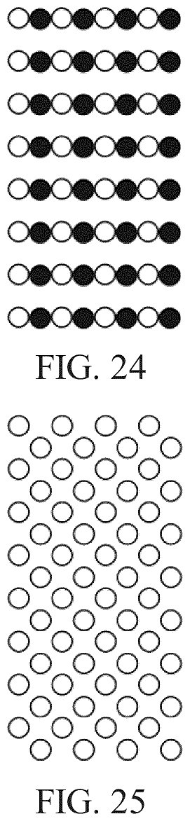

FIGS. 23 and 24 illustrate two possible output patterns of the optical switch according to the possible landing sites shown in FIG. 22. The landing sites of the output optical signals shown in FIG. 23 may be viewed as consisting of eight patterns shown in FIG. 7, and the landing sites of the output optical signals shown in FIG. 24 may be viewed as consisting of eight patterns shown in FIG. 8.

As mentioned earlier, M input optical fibers may be arranged in a one-dimensional array, and the output pattern changes when the position of the first AOD changes. Similarly, in a case where the M input optical fibers are arranged in a two-dimensional array, the output pattern also changes when the position of the first AOD changes.

In a case where the first AOD is in the position shown in FIGS. 15 and 16, and the input optical signals are arranged as shown in FIG. 21, possible landing sites of output optical signals will be described in conjunction with FIGS. 25 to 27.

FIG. 25 illustrates an example output facet landing site pattern of output optical signals of the optical switch according to the input facet beam pattern shown in FIG. 21. The possible landing sites of the output optical signals shown in FIG. 25 may be viewed as consisting of eight patterns shown in FIG. 18.

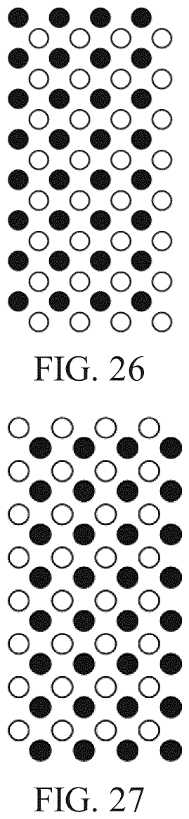

FIGS. 26 and 27 illustrate two possible output patterns of the optical switch according to the landing sites shown in FIG. 25. Similarly, the landing sites of the output optical signals shown in FIG. 26 may be viewed as consisting of eight patterns shown in FIG. 19. The landing sites of the output optical signals shown in FIG. 27 may be viewed as consisting of eight patterns shown in FIG. 20.

In a case where M input fibers are arranged in a two-dimensional array, relative positions between different input optical signals may also be adjusted, thus providing flexible options for multi-channel output of optical signals and facilitating the application of optical switches in more scenarios.

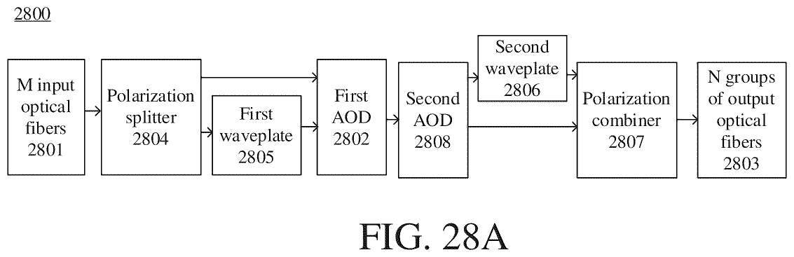

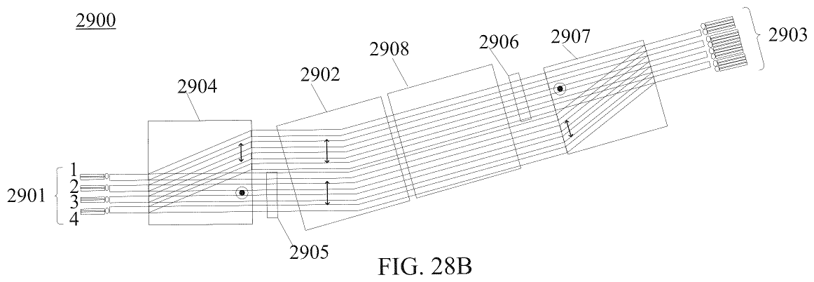

FIG. 28A is a block diagram of an optical switch in accordance with some embodiments of the present disclosure. As shown in FIG. 28A, in some embodiments, the optical switch 2800 may further include a second AOD 2808 configured to control a propagation direction of the M optical signals output from the first AOD 2802, so that the M optical signals are coupled to the any one of the N groups of output optical fibers 2803. A longitudinal axis of the second AOD 2808 overlaps a longitudinal axis of the first AOD 2802, and a beam deflection axis of the second AOD 2808 is not parallel to a beam deflection axis of the first AOD 2802.

FIG. 28B illustrates a schematic diagram of the optical switch in accordance with some embodiments of the present disclosure. The optical switch 2900 is similar to the optical switch 500, and the same parts are not repeated here. The difference is that the optical switch 2900 shown in FIG. 28B further includes a second AOD 2908, so that the optical switch 2900 may include two AODs, which may deflect the input optical signals separately. In addition, the beam deflection axes of the two AODs are not parallel, so that landing sites of the output optical signals may not overlap after the two AODs separately deflect the input optical signals. In this case, more possible landing sites of the output optical signals may be achieved. In addition, the number of groups of output optical fibers and the number of output optical fibers 2903 may be different from those when the optical switch includes only one AOD. The optical switch 2900 may realize more possible output patterns, and thus may be used in more scenarios.

In some embodiments, the operating frequency of the second AOD 2908 includes a third frequency or a fourth frequency, the absolute value of the difference between the third frequency and the nominal frequency of the second AOD 2908 is equal to the absolute value of the difference between the fourth frequency and the nominal frequency of the second AOD 2908, and the nominal frequency of the second AOD 2908 is an operating frequency that makes the second AOD 2908 have a second nominal diffraction efficiency.

Similar to the first AOD 2902, the second AOD 2908 may have a uniform loss between two output states at the two operating frequencies (i.e., the third and fourth frequencies), thereby reducing the cost while maintaining the system performance.

Commercial AODs routinely declare a diffraction efficiency (i.e., an effective transmission rate of an optical signal) of 90% or above. In this case, the loss may be 0.458 decibel (dB) or even less. Assume that a reasonable insertion loss is 0.5 dB per beam deflection axis (or per AOD in a system). Diffraction efficiency may be reduced in a case where the driving frequency (i.e., operating frequency) of the AOD deviates from the optimal frequency. Currently commercial AODs typically operate at about (plus or minus) 50% of the optimal frequency itself, which means that the loss may include an additional 3 dB at these operation frequencies. In addition, there may be a reference loss of 0.5 dB in an AOD (a loss that may be unavoidable even if the AOD operates at the optimal frequency). In a case where the operating frequency of the AOD is shifted by 50% above and below the optimal frequency, the insertion loss may be approximately 3.5 dB.

In the embodiments of the present disclosure, the frequency swing of the AOD in the optical switch may be limited to within plus or minus 10% of the optimal frequency. For two operating frequencies that are equally far from the optimal frequency, the diffraction efficiency and insertion loss are similar. In this case, the optical switch that includes two AODs (as shown in FIG. 28) may have an insertion loss of 2 dB or less by correctly designing the optical switch and limiting the driving frequency range of the AODs, which may be beneficial for ensuring the system performance.

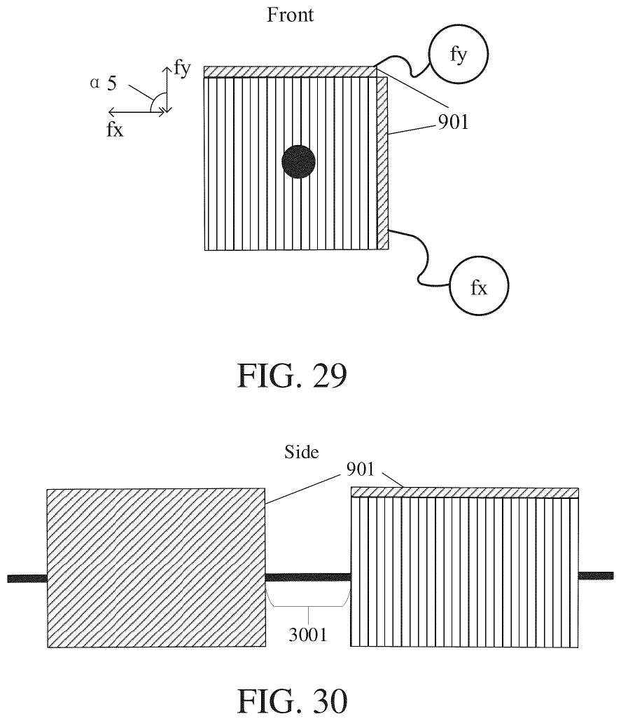

For ease of understanding, possible positions and output patterns of the first AOD and the second AOD will be illustrated below in conjunction with FIGS. 29 to 34, using an input optical signal as an example.

In a possible implementation, a beam deflection axis of the second AOD is perpendicular to a beam deflection axis of the first AOD.

For example, a position of the first AOD is shown in FIGS. 9 and 10, and the position of the second AOD is shown in FIGS. 12 and 13. In this case, FIG. 29 illustrates a front view of the first AOD and the second AOD in the optical switch. Similarly, the beam deflection axis of the first AOD may extend in the direction fx and the beam deflection axis of the second AOD may extend in the direction fy. An angle α5 between the directions fx and fy may be 90 degrees.

FIG. 30 is a side view of the first AOD and the second AOD in the optical switch. For example, FIG. 30 illustrates a right view with the thick line indicating an operational axis (the longitudinal axis).

It is noticed that the positions of the AODs are positions at which the AODs operate after rotating with the longitudinal axis as the axis of rotation. A distance between the first AOD and the second AOD along the longitudinal axis (e.g., the distance 3001 shown in FIG. 30) may be arbitrary, and may be set according to actual requirements.

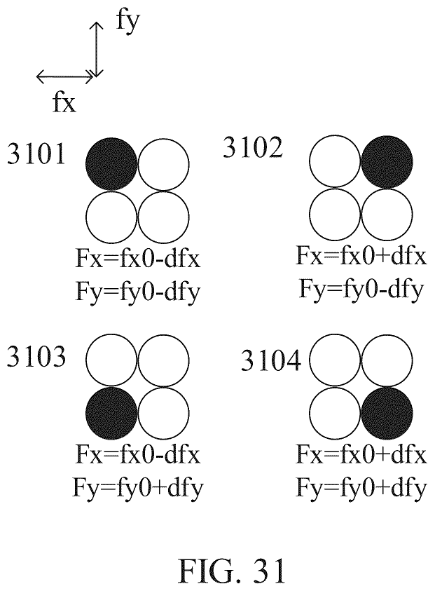

FIG. 31 are four possible output patterns (shown as 3101 to 3104) of an input optical signal in a case where the first AOD and the second AOD operate at the position shown in FIGS. 29 and 30. Meanings of elements in FIG. 31 may be referred to FIGS. 11 and 14 and will not be repeated here. In this case, possible landing sites of the output optical signal may be jointly determined by Fx and Fy, which may provide possible choice of output patterns for the optical switch.

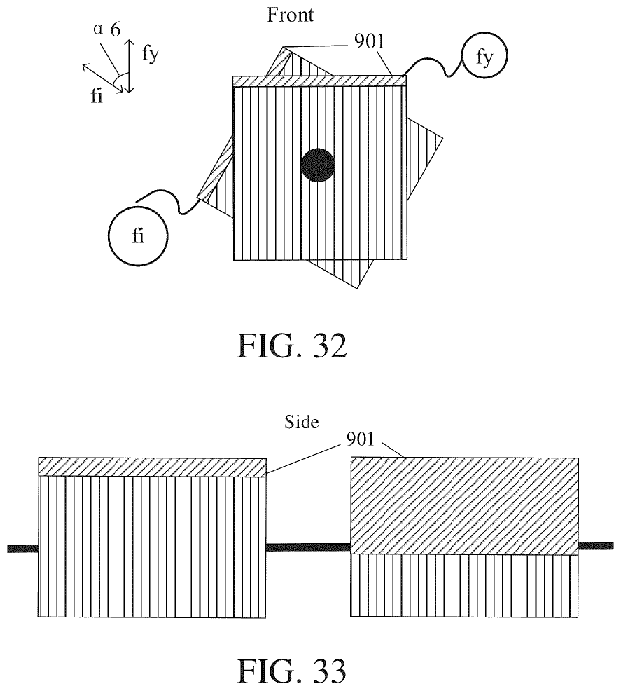

In another possible implementation, an angle between the beam deflection axis of the second AOD and the beam deflection axis of the first AOD is 60 degrees. FIG. 32 is a front view of the first AOD and the second AOD in the optical switch. Similarly, the beam deflection axis of the first AOD may extend in the direction fy and the beam deflection axis of the second AOD may extend along the direction fi. An angle α6 between the directions fy and fi may be 60 degrees.

FIG. 33 is a side view of the first AOD and the second AOD in the optical switch. For example, FIG. 33 illustrates a right view with the thick line indicating an operational axis (the longitudinal axis).

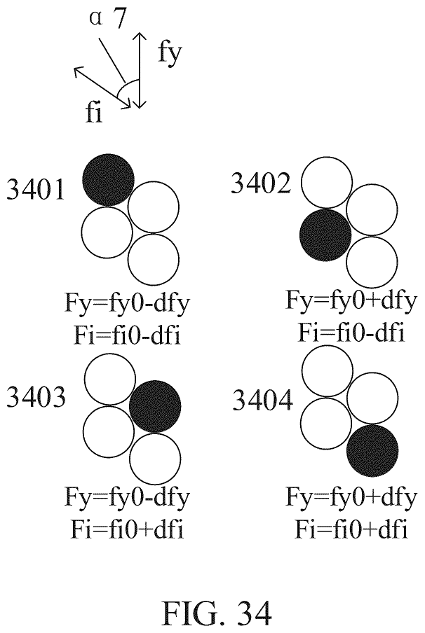

FIG. 34 are four possible output patterns of an input optical signal in a case where the first AOD and the second AOD operate at the position shown in FIGS. 32 and 33. Fi may refer to a landing site of an output optical signal after the second AOD deflects an input optical signal in the direction fi in a case where the second AOD operates at the third or fourth frequency. fio may refer to a landing site of an output optical signal after the second AOD deflects an input optical signal in the direction fi in a case where the second AOD operates at the optimal frequency. dfi may refer to a distance between fio and the landing site of an output optical signal after the second AOD deflects the input optical signal in the direction fi in a case where the second AOD operates at the third or fourth frequency. An angle α7 between the directions fy and fi is 60 degrees. In this case, a landing site of an output optical signal may be jointly determined by Fy and Fi, which may provide possible choices of the output pattern for the optical switch.

It is noticed that two different relative positions of the first AOD and the second AOD have been described in conjunction with FIGS. 28 to 34, but in actual application, an angle between the beam deflection axes of the first AOD and the second AOD may be any other degree.

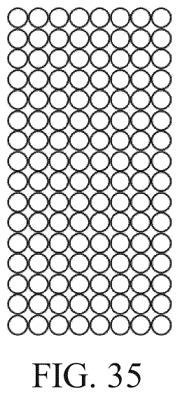

Possible positions of the first AOD and the second AOD as well as possible output patterns in a case where the M input optical fibers may be arranged in a two-dimensional array will be described below in conjunction with FIGS. 35 to 38.

FIG. 35 illustrates an example output facet beam landing site pattern of output optical signals of the optical switch in a case where the first AOD and the second AOD operate at the position shown in FIGS. 29 and 30 and in a case where the input facet beam pattern of the optical switch is as shown in FIG. 21. FIG. 35 is similar to FIG. 22, with the difference that the optical switch corresponding to FIG. 22 has one AOD, so there are two possible output patterns for an input optical signal, whereas the optical switch corresponding to FIG. 35 has two AODs, so there are four possible output patterns (shown as 3101 to 3104) for an input optical signal. As shown in FIG. 35, in a case where the input facet beam pattern is 4×8, possible landing sites of the output optical signals may be 8×16.

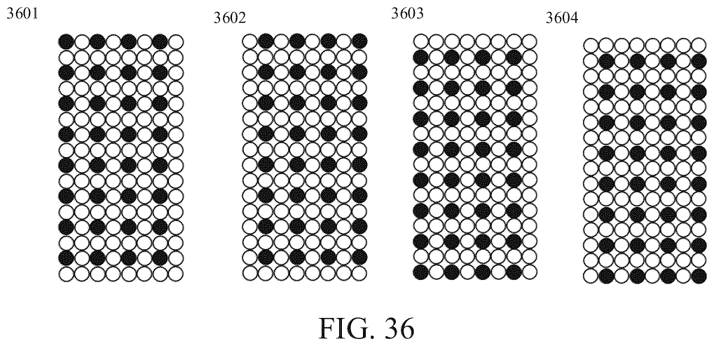

FIG. 36 illustrates four possible output patterns of the optical switch according to the landing sites shown in FIG. 35. In output pattern 3601, each of the input optical signals shown in FIG. 21 may be output in pattern 3101 in FIG. 31. In output pattern 3602, each of the input optical signals shown in FIG. 21 may be output in pattern 3102 in FIG. 31. In output pattern 3603, each of the input optical signals shown in FIG. 21 may be output in pattern 3103 in FIG. 31. In output pattern 3604, each of the input optical signals shown in FIG. 21 may be output in pattern 3104 in FIG. 31.

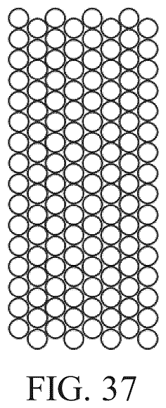

FIG. 37 illustrates an example output facet beam landing site pattern of output optical signals of the optical switch in a case where the first AOD and the second AOD operate at the position shown in FIGS. 32 and 33 and in a case where the input facet beam pattern of the optical switch is as shown in FIG. 21. FIG. 37 is similar to FIG. 35, the difference is that a relative position between the first AOD and the second AOD is changed, resulting in a change in the possible landing sites of the output optical signals. Among the possible landing sites of the output optical signals shown in FIG. 37, there are four possible output patterns for each of the input optical signals in FIG. 21.

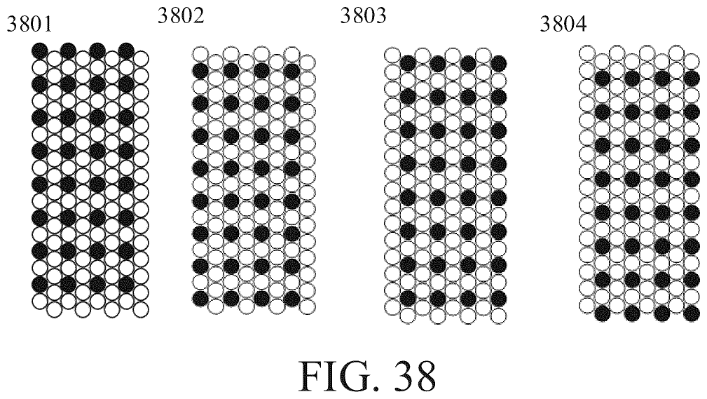

FIG. 38 illustrates the four possible output patterns of the optical switch according to the landing sites shown in FIG. 37. In output pattern 3801, each of the input optical signals shown in FIG. 21 may be output in pattern 3401 in FIG. 34. In output pattern 3802, each of the input optical signals shown in FIG. 21 may be output in pattern 3402 in FIG. 34. In output pattern 3803, each of the input optical signals shown in FIG. 21 may be output in pattern 3403 in FIG. 34. In output pattern 3804, each of the input optical signals shown in FIG. 21 may be output in pattern 3404 in FIG. 34.

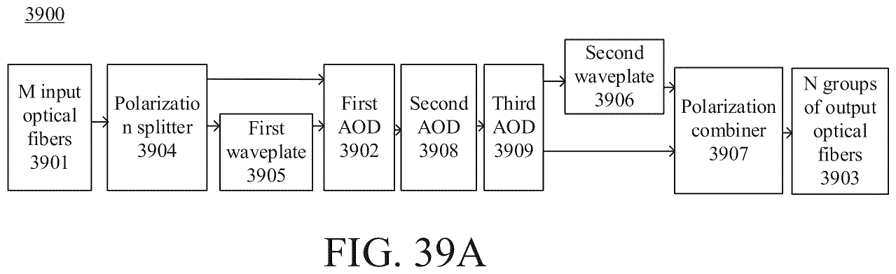

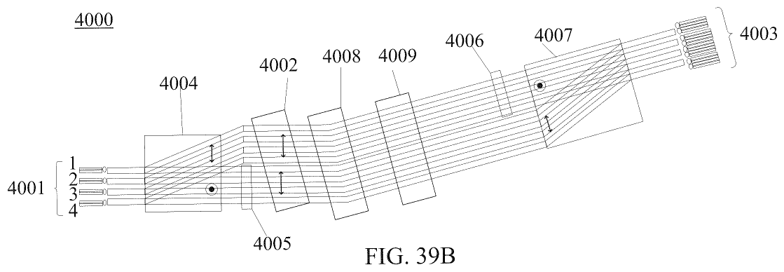

FIG. 39A illustrates a block diagram of an optical switch in accordance with some embodiments of the present disclosure.

As shown in FIG. 39A, in some embodiments, the optical switch 3900 further includes a third AOD 3909 configured to control a propagation direction of the M optical signals output from the second AOD 3908, so that the M optical signals are coupled to the any one of the N groups of output optical fibers 3902. A longitudinal axis of the third AOD 3909, the longitudinal axis of the second AOD 3908 and the longitudinal axis of the first AOD 3903 overlap, and a beam deflection axis of the third AOD 3909 is not parallel to either the beam deflection axis of the second AOD 3908 or the beam deflection axis of the first AOD 3903.

FIG. 39B illustrates a schematic diagram of the optical switch in accordance with some embodiments of the present disclosure. The optical switch 4000 is similar to the optical switch 2900, and the same parts are not repeated here. The difference is that the optical switch 4000 further includes a third AOD 4009, so that the optical switch 4000 includes three AODs, each of which may deflect the input optical signals separately. In addition, the beam deflection axes of all three AODs are not parallel, so that landing sites of the output optical signals may not overlap after the three AODs separately deflect the input optical signals. In this case, more possible landing sites of the output optical signals may be achieved. In addition, the number of groups of output optical fibers and the number of output optical fibers 4002 may be different from those when the optical switch includes only one AOD or two AODs. The optical switch 4000 may realize more possible output patterns, and thus may be used in more scenarios.

In some embodiments, the first AOD 4002 is further configured to operate at the nominal frequency of the first AOD, the second AOD 4002 is further configured to operate at the nominal frequency of the second AOD 4008, and the third AOD 4009 is further configured to operate at a fifth frequency, a sixth frequency, or a nominal frequency of the third AOD 4009. An absolute value of a difference between the fifth frequency and the nominal frequency of the third AOD 4009 is equal to an absolute value of a difference between the sixth frequency and the nominal frequency of the third AOD 4009, and the nominal frequency of the third AOD 4009 is an operating frequency that enables the third AOD 4009 to have a third nominal diffraction efficiency.

Similar to the first AOD 4002 and the second AOD 4008, the third AOD 4009 may have uniform loss between two output states at the fifth and the sixth frequencies, thereby reducing the cost while maintaining the system performance. As mentioned earlier, the nominal frequency of the AOD refers to the optimal frequency that makes the AOD have a maximum diffraction efficiency. All three AODs in the optical switch may operate at their respective optimal frequencies, further increasing the possible output patterns.

It is noticed that the optimal frequencies of the three AODs in the optical switch may be the same or different, and it is not limited thereto.

It is also noticed that the maximum diffraction efficiencies of the three AODs in the optical switch may be the same or different, and it is not limited thereto.

In some embodiments, an angle between the beam deflection axis of the third AOD and the beam deflection axis of the second AOD is 60 degrees, an angle between the beam deflection axis of the third AOD and the beam deflection axis of the first AOD is 60 degrees, and an angle between the beam deflection axis of the second AOD and the beam deflection axis of the first AOD is 60 degrees.

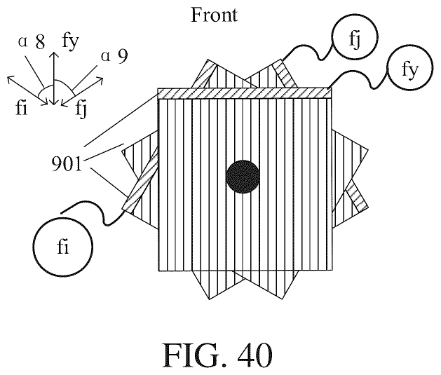

For ease of understanding, possible positions and output patterns of the first AOD, the second AOD, and the third AOD will be illustrated below in conjunction with FIGS. 40 to 43, using an optical signal as an example.

In a possible implementation, the positions of the first AOD and the second AOD are shown in FIGS. 32 and 33 (the angle between the beam deflection axis of the second AOD and the beam deflection axis of the first AOD is 60 degrees). In addition, the angle between the beam deflection axis of the third AOD and the beam deflection axis of the first AOD is also 60 degrees.

In this case, FIG. 40 illustrates a front view of the first AOD, the second AOD in the optical switch. Similarly, the beam deflection axis of the first AOD may extend in the direction fy, the beam deflection axis of the second AOD may extend in the direction fi, and the beam deflection axis of the third AOD may extend in the direction fj. An angle α8 between the directions fy and fi may be 60 degrees. An angle α9 between the directions fy and fj may also be 60 degrees.

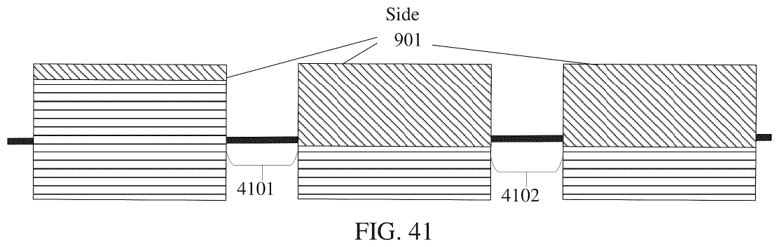

FIG. 41 is a side view of the first AOD, the second AOD, and the third AOD in the optical switch. For example, FIG. 41 illustrates a right view with the thick line indicating an operational axis (the longitudinal axis).

It is noticed that the positions of the AODs are positions at which the AODs operate after rotating with the longitudinal axis as the axis of rotation. A distance between the first AOD and the second AOD along the longitudinal axis (e.g., the distance 4101 shown in FIG. 41) may be arbitrary, and a distance between the second AOD and the third AOD along the longitudinal axis (e.g., the distance 4102 shown in FIG. 41) may also be arbitrary. These distances may be set according to actual requirements.

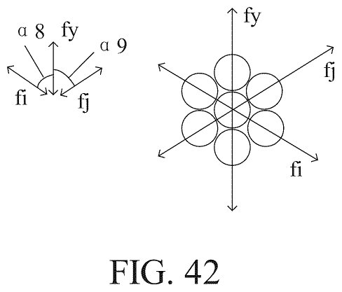

FIG. 42 is an example output facet landing site pattern of output optical signals of the optical switch in a case where the first AOD, the second AOD and the third AOD operate at the position shown in FIGS. 40 and 41. Seven dots shown in FIG. 42 indicates seven possible landing sites for an input optical signal. In a case where all three AODs operate at their respective optimal frequencies, a possible landing site of the input optical signal is the middle-most dot. As shown in FIG. 42, because each AOD has three possible operating frequencies, there may be three possible output patterns for each input optical signal in each of the three directions fy, fi and fj. However, the landing sites are arranged in a same two-dimensional plane, so that the possible middle landing sites for the input optical signal in the three directions may overlap, and thus there may exist seven possible landing sites for the input optical signal.

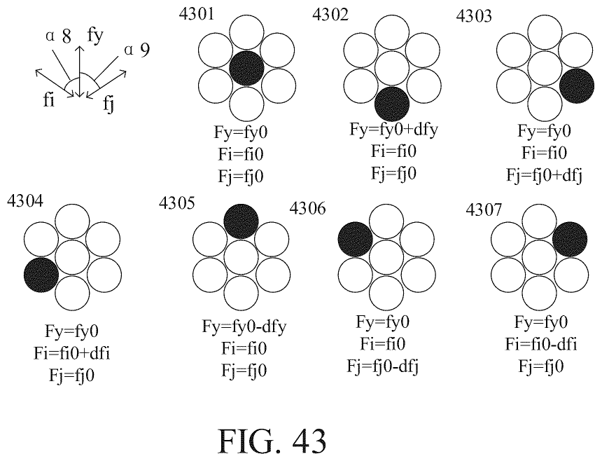

FIG. 43 illustrates seven possible output patterns (shown as 4301 to 4307) of the optical switch according to the landing sites shown in FIG. 42. fjo may refer to a landing site of an output optical signal after the third AOD deflects an input optical signal in the direction fj in a case where the third AOD operates at the optimal frequency. dfj may refer to a distance between fjo and the landing site of an output optical signal after the third AOD deflects the input optical signal in the direction fj in a case where the third AOD operates at a fifth or sixth frequency other than the optimal frequency. In this case, a position of a landing site of an output optical signal may be jointly determined by Fy, Fi and Fj, which may provide possible choices for the output pattern of the optical switch.

It is noticed that a possible relative position of the first AOD, the second AOD and the third AOD has been described in conjunction with FIGS. 39 to 43, but in actual application, an angle between the beam deflection axes of the first AOD and the second AOD may be any other degree, and an angle between the beam deflection axes of the second AOD and the third AOD may also be any other degree.

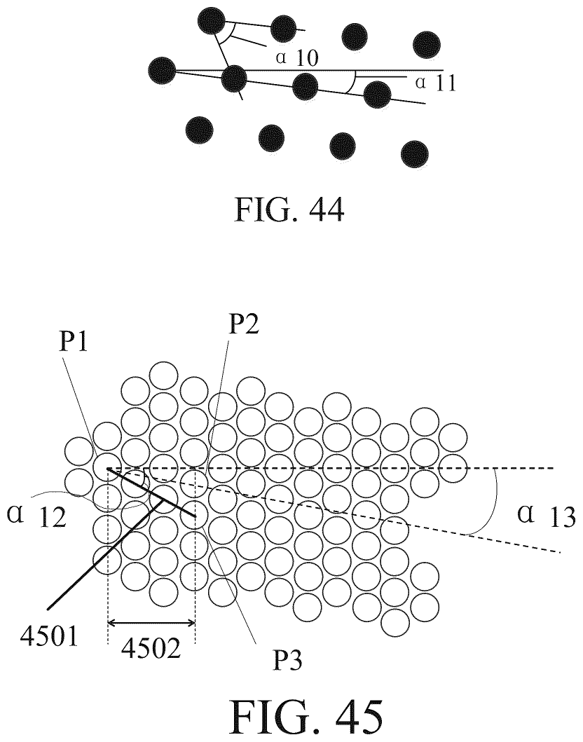

As mentioned earlier, the M input fibers may be arranged in a two-dimensional array. In this case, the possible input facet beam pattern as well as the output patterns will be described in conjunction with FIGS. 44 to 46.

In a possible implementation, in a case where the M input fibers are arranged in a two-dimensional array, a row direction and a column direction of the two-dimensional array are not perpendicular.

FIG. 44 illustrates another possible input facet beam pattern. FIG. 44 is similar to FIG. 21, and the difference is that in the input facet beam pattern shown in FIG. 44, a row direction and a column direction may not be perpendicular and may have an angle of any degree therebetween. In FIG. 44, a possible angle α10 between the row direction and the column direction may be 60 degrees. In an implementation, an angle α11 between the row direction and the horizontal direction may be about 10. 88 degrees, and a calculation process will be described in FIG. 45. It is noticed that an angle between the row direction and the column direction may be any other degree, and it is not limited thereto. In this case, the input facet beam pattern of the optical switch may have more possible choices, which may be conducive to greater flexibility.

FIG. 45 is an example output facet beam landing site pattern of output optical signals of the optical switch in a case where the first AOD, the second AOD, and the third AOD operate at the position shown in FIGS. 40 and 41 and in a case where the input facet beam pattern of the optical switch is as shown in FIG. 44. FIG. 45 may be viewed as an extension of FIG. 42. For example, for each input optical signal in the input facet beam pattern shown in FIG. 44, there may be seven possible landing sites (as shown in FIG. 42). It is noticed that each landing site may be a circle of radius R. In an implementation, a vertical distance between circle P1 and circle P2 is R. A line joining centers of the circle P2 and circle P3 extends in a vertical direction and has a length of 2R. A line 4501 joining centers of the circle P1 and the circle P3 has a length of 6R and an angle α12 between the line 4501 and the horizontal direction is 30 degrees. In this case, a horizontal distance 4502 between the circle P1 and the circle P2 is 6R*cos (300)=5.2R. And an angle α13 between the horizontal direction and a line joining centers of the circle P1 and the circle P2 is atan (R/5.2R)=10.88 degrees, which may exactly be the angle α11 in FIG. 44.

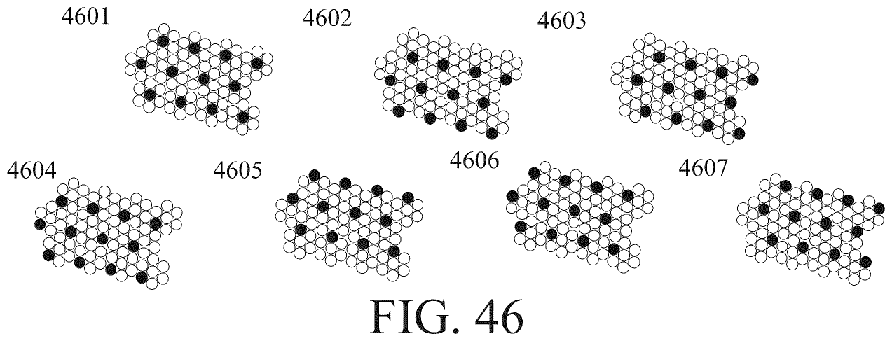

FIG. 46 illustrates seven possible output patterns of the optical switch according to the possible landing sites shown in FIG. 45. In output pattern 4601, each of the input optical signals shown in FIG. 44 may be output in pattern 4301 in FIG. 43. In output pattern 4602, each of the input optical signals shown in FIG. 44 may be output in pattern 4302 in FIG. 43. In output pattern 4603, each of the input optical signals shown in FIG. 44 may be output in pattern 4303 in FIG. 43. In output pattern 4604, each of the input optical signals shown in FIG. 44 may be output in pattern 4304 in FIG. 43. In output pattern 4605, each of the input optical signals shown in FIG. 44 may be output in pattern 4305 in FIG. 43. In output pattern 4606, each of the input optical signals shown in FIG. 44 may be output in pattern 4306 in FIG. 43. In output pattern 4607, each of the input optical signals shown in FIG. 44 may be output in pattern 4307 in FIG. 43.

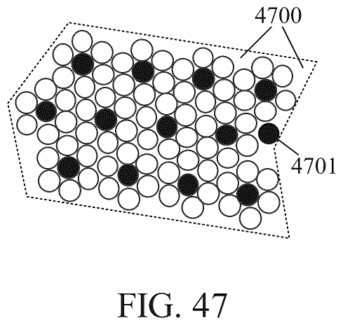

In this case, there may be seven different output patterns for an input optical signal, which may facilitate a flexibility of the output patterns. But there are still some vacant landing sites (i.e., there are no possible output optical signals at that position), such as 4700 in FIG. 47. As mentioned earlier, in the input facet beam pattern, the row direction and the column direction may not be perpendicular, but at an arbitrary angle, and it is therefore possible to supplement the vacant landing sites for the output optical signals by making flexible adjustments to the input facet beam pattern. In FIG. 47, some possible landing sites 4701 are shown, further facilitating the flexibility of the output patterns.

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

In the present disclosure, the terms “a”, “an” and “one” are defined to mean “at least one”, that is, these terms do not exclude a plural number of items, unless stated otherwise.

Unless the context requires otherwise, throughout the description and the claims, the term “comprise” and other forms thereof such as the third-person singular form “comprises” and the present participle form “comprising” are construed as open and inclusive meanings, i.e., “including, but not limited to”. In the description, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or examples(s). In addition, the specific features, structures, materials or characteristics may be included in any one or more embodiments or examples in any suitable manner.

Hereafter, the terms “first” and “second” are used for descriptive purposes only, and are not to be construed as indicating or implying the relative importance or implicitly indicating the number of indicated technical features. Thus, a feature defined with “first” or “second” may explicitly or implicitly include one or more of the features. In the description of the embodiments of the present disclosure, the terms “a/the plurality of” and “multiple” means two or more unless otherwise specified.

In the description of some embodiments, the terms “coupled” and “connected” and derivatives thereof may be used. For example, the term “connected” may be used in the description of some embodiments to indicate that two or more components are in direct physical or electrical contact with each other. For another example, the term “coupled” may be used in the description of some embodiments to indicate that two or more components are in direct physical or electrical contact. However, the term “coupled” may also mean that two or more components are not in direct contact with each other, but still cooperate or interact with each other. The embodiments disclosed herein are not necessarily limited to the content herein.

In the present disclosure, “at least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” usually indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes A, B, C, A and B, A and C, B and C, or A, B, and C, and “at least one of A, B, and C” may also be understood as including A, B, C, A and B, A and C, B and C, or A, B, and C.

In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

It is noted that the method may also include other well-known method for forming other components, layers or elements, which are not illustrated or described in detail to avoid obscuring pertinent aspects of the embodiments described herein.

It should be understood that in the various embodiments of the present disclosure, the size of the serial numbers of the above-mentioned processes does not mean the order of execution, and the order of execution of each process shall be determined by its function and internal logic, and shall not constitute any limitation on the implementation of the embodiments of the present disclosure.

The foregoing descriptions are merely specific implementations of the present disclosure, but the protection scope of the present disclosure is not limited thereto. Any changes or replacements that a person skilled in the art could readily conceive of within the technical scope of the present disclosure shall be included in the protection scope of the present disclosure. Therefore, the protection scope of the present disclosure shall be subject to the protection scope of the claims. Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

What is claimed is:

1. An optical switch comprising:
M input optical fibers configured to receive M optical signals respectively, wherein Mis an integer greater than or equal to 1;
a first acousto-optic deflector (AOD) configured to control a propagation direction of the M optical signals, such that the M optical signals are coupled to any one of N groups of output optical fibers, wherein the first AOD is configured to operate at a first frequency or a second frequency, an absolute value of a difference between the first frequency and a nominal frequency of the first AOD is equal to an absolute value of a difference between the second frequency and the nominal frequency of the first AOD, and the nominal frequency of the first AOD is an operating frequency that enables the first AOD to have a first nominal diffraction efficiency; and
the N groups of output optical fibers, wherein each of the N groups of output optical fibers comprises M output optical fibers, the N groups of output optical fibers are configured to output the M optical signals through M output optical fibers of the any one of the N groups of output optical fibers, respectively, and N is an integer greater than 1.

2. The optical switch of claim 1, further comprising:
a polarization splitter configured to split the M optical signals from the M input optical fibers into M first optical signals having a first polarization direction and M second optical signals having a second polarization direction orthogonal to the first polarization direction;
a first waveplate configured to convert the M second optical signals from having the second polarization direction to having the first polarization direction, wherein the first AOD is configured to control a propagation direction of the M first optical signals and the M second optical signals output from the first waveplate;
a second waveplate configured to convert the M first optical signals output from the first AOD from having the first polarization direction to having the second polarization direction, or convert the M second optical signals from having the first polarization direction to having the second polarization direction; and
a polarization combiner configured to combine the M first optical signals output from the second waveplate and the M second optical signals output from the first AOD, or configured to combine the M second optical signals output from the second waveplate and the M first optical signals output from the first AOD, to obtain and transmit combined M optical signals to the any one of the N groups of output optical fibers.

3. The optical switch of claim 1, further comprising:
a second AOD configured to control a propagation direction of the M optical signals output from the first AOD, so that the M optical signals are coupled to the any one of the N groups of output optical fibers, wherein a longitudinal axis of the second AOD overlaps a longitudinal axis of the first AOD, and a beam deflection axis of the second AOD is not parallel to a beam deflection axis of the first AOD.

4. The optical switch of claim 3, wherein the second AOD is configured to operate at a third frequency or a fourth frequency, an absolute value of a difference between the third frequency and a nominal frequency of the second AOD is equal to an absolute value of a difference between the fourth frequency and the nominal frequency of the second AOD, and the nominal frequency of the second AOD is an operating frequency that enables the second AOD to have a second nominal diffraction efficiency.

5. The optical switch of claim 3, wherein the beam deflection axis of the second AOD is perpendicular to the beam deflection axis of the first AOD.

6. The optical switch of claim 3, wherein an angle between the beam deflection axis of the second AOD and the beam deflection axis of the first AOD is 60 degrees.

7. The optical switch of claim 4, further comprising:
a third AOD configured to control a propagation direction of the M optical signals output from the second AOD, so that the M optical signals are coupled to the any one of the N groups of output optical fibers, wherein a longitudinal axis of the third AOD, the longitudinal axis of the second AOD and the longitudinal axis of the first AOD overlap, and a beam deflection axis of the third AOD is not parallel to either the beam deflection axis of the second AOD or the beam deflection axis of the first AOD.

8. The optical switch of claim 7, wherein the first AOD is further configured to operate at the nominal frequency of the first AOD, the second AOD is further configured to operate at the nominal frequency of the second AOD, the third AOD is configured to operate at a fifth frequency, a sixth frequency, or a nominal frequency of the third AOD, an absolute value of a difference between the fifth frequency and the nominal frequency of the third AOD is equal to an absolute value of a difference between the sixth frequency and the nominal frequency of the third AOD, and the nominal frequency of the third AOD is an operating frequency that enables the third AOD to have a third nominal diffraction efficiency.

9. The optical switch of claim 7, wherein an angle between the beam deflection axis of the third AOD and the beam deflection axis of the second AOD is 60 degrees, an angle between the beam deflection axis of the third AOD and the beam deflection axis of the first AOD is 60 degrees, and an angle between the beam deflection axis of the second AOD and the beam deflection axis of the first AOD is 60 degrees.

10. The optical switch of claim 1, wherein the M input optical fibers are arranged in a two-dimensional array.

11. The optical switch of claim 10, wherein a row direction and a column direction of the two-dimensional array are not perpendicular.
